(19) United States
(12) Patent Application Publication
(10) Pub. No.: US 2023/0030406 A1
(43) Pub. Date: Feb. 2, 2023

(54) MASSAGE DEVICE AND OPERATION METHOD CAPABLE OF REPOSITIONING WHEN POWER FAILURE OCCURS

(71) Applicant: BODYFRIEND CO., LTD., SEOUL (KR)

(72) Inventors: HAN IL KIM, Seoul (KR); TAE HWAN LEE, Seoul (KR)

(21) Appl. No.: 17/788,508

(22) PCT Filed: Dec. 23, 2020
(86) PCT No.: PCT/KR2020/019020

§ 371 Date: Jun. 23, 2022

(30) Foreign Application Priority Data
Dec. 27, 2019 (KR) 10-2019-0176081

(51) Int. Cl. A61G 15/02; A61H 7/00; A61H 23/00; A61G 15/00

(52) U.S. Cl. CPC A61G 15/02; A61H 7/007; A61H 23/006; A61G 15/007; A61H 2201/0149; A61H 2201/0188; A61H 2201/5043; A61H 2201/1623; A61H 2201/164; A61H 2201/0196; A61H 2201/5007; A61H 2201/1207

(57) ABSTRACT

The present disclosure relates to a massage device capable of repositioning when a power failure occurs, comprising: an energy storage unit that stores electrical energy supplied from a power supply unit; an input unit that receives an input from a user when the electric energy supply is cut off from the power supply unit; a back angle actuator that receives, on the basis of the input unit, electric energy from the energy storage unit and moves a body massage unit such that the massage device is in an initial state; and a leg angle actuator that receives, on the basis of the input unit, electric energy from the energy storage unit and moves a leg massage unit such that the massage device is in an initial state.

### TECHNICAL FIELD

The present disclosure relates to a massage device, and more particularly, to a massage device capable of repositioning during a power outage.

### BACKGROUND ART

A massage is a medical adjuvant therapy that regulates modulation of the body of a subject, assists in blood circulation, and relieves fatigue of the subject by applying various types of mechanical stimulation to a part of the body, such as kneading, pressing, pulling, tapping, or moving a part of the body of the subject.

For economic and time reasons, an increase in massage demand has led to an increase in demand for a massage device or massage apparatus for providing an artificial massage function. That is, with an increase in demand to relieve fatigue or stress by relaxing tightened muscles through a massage, various time and cost-effective massage devices have been released. Any types of equipment, devices, or apparatuses that perform a massage through mechanical devices without a separate masseur are referred to as massage devices.

While a user is receiving a massage, there is a case in which the user is in danger from a massage device due to a sudden abnormal operation of a power supply device.

Therefore, research is continuously conducted on a safety device that allows a user to safely escape from a massage device even when a power supply device operates abnormally.

### DISCLOSURE

### Technical Problem

The present disclosure is directed to providing a safety device such that, when the supply of power to a massage device is stopped while a user is receiving a massage, the massage device allows the user to be easily escaped therefrom.

Technical solutions of embodiments may not be limited to the above, and other technical solutions which are not described herein should be clearly understood by those skilled in the art, to which the present disclosure belongs, from the present specification and the accompanying drawings.

### Technical Solution

According to one embodiment of the present disclosure, a massage device includes an energy storage unit configured to store electrical energy supplied from a power supply unit, an input unit configured to receive an input from a user when supply of the electrical energy from the power supply unit is cut off, a back angle actuator which receives the electrical energy from the energy storage unit based on the input unit and moves a body massage unit such that the massage device is in an initial state, and a leg angle actuator which receives the electrical energy from the energy storage unit based on the input unit and moves a leg massage unit such that the massage device is in the initial state.

When the supply of the electrical energy from the power supply unit is cut off, based on the input unit, the electrical energy from the energy storage unit may be supplied to at least one of the back angle actuator and the leg angle actuator.

When the supply of the electrical energy from the power supply unit is cut off, a light source included in the input unit may flicker light for a preset time using the electrical energy supplied to the energy storage unit.

The massage device may further include a controller which operates using the electrical energy supplied from the power supply unit or the energy storage unit and measures an amount of the electrical energy remaining in the energy storage unit.

The massage device may further include a display unit configured to display the amount of the electrical energy remaining in the energy storage unit based on the amount of the electrical energy remaining in the energy storage unit.

When the amount of the electrical energy remaining in the energy storage unit is less than or equal to a threshold value, the controller may control the power supply unit to charge the energy storage unit.

When the supply of the electrical energy from the power supply unit is cut off, the controller may store log information, which includes a time at which the supply of the electrical energy from the power supply unit is cut off, a time at which the supply of the electrical energy from the power supply unit is started, a voltage supplied from the power supply unit, a current supplied from the power supply unit, an operating state of the massage device, the amount of the electrical energy remaining in the energy storage unit, and an operating time of the back angle actuator or an operating time of the leg angle actuator, in a memory.

When the power supply unit does not supply the electrical energy for a certain time, the controller may control the energy storage unit to discharge the electrical energy.

According to another embodiment of the present disclosure, a method of operating a massage device includes storing, by an energy storage unit, electrical energy supplied from a power supply unit, when supply of the electrical energy from the power supply unit is cut off, receiving, by an input unit, an input from a user, receiving, by a back angle actuator, the electrical energy from the energy storage unit based on the input unit and moving a body massage unit such that the massage device is in an initial state, and receiving, by a leg angle actuator, the electrical energy from the energy storage unit based on the input unit and moving a leg massage unit such that the massage device is in the initial state.

The method may further include, when the supply of the electrical energy from the power supply unit is cut off, flickering, by a light source included in the input unit, light for a predetermined time using the electrical energy supplied to the energy storage unit.

The method may further include measuring, by a controller, an amount of the electrical energy remaining in the energy storage unit, wherein the controller operates using the electrical energy supplied from the power supply unit or the energy storage unit.

The method may further include, when the supply of the electrical energy from the power supply unit is cut off, storing, by the controller, log information, which includes a time at which the supply of the electrical energy from the power supply unit is cut off, a time at which the supply of the electrical energy from the power supply unit is started, a voltage supplied from the power supply unit, a current supplied from the power supply unit, an operating state of the massage device, the amount of the electrical energy remaining in the energy storage unit, and an operating time of the back angle actuator or an operating time of the leg angle actuator, in a memory.

A program for implementing the method of operating a massage device as described above may be recorded on a computer-readable recording medium.

### Advantageous Effects

According to one embodiment of the present disclosure, a massage device has an effect in which an energy storage unit can secure the safety of a user even when a power supply unit is in an abnormal state.

### DESCRIPTION OF DRAWINGS

FIG. 1 shows diagrams for describing a massage device according to one embodiment of the present disclosure.

FIG. 2 is a diagram for describing a main frame according to one embodiment of the present disclosure.

FIG. 3 is a diagram illustrating a massage device according to one embodiment of the present disclosure.

FIG. 4 shows diagrams illustrating an external device capable of communicating with a massage device (100) according to one embodiment of the present disclosure.

FIG. 5 is a block diagram of a massage device according to one embodiment of the present disclosure.

FIG. 6 illustrates an input unit (530) according to one embodiment of the present disclosure.

FIG. 7 shows diagrams illustrating the operation of a massage device according to one embodiment of the present disclosure.

FIG. 8 shows diagrams illustrating the operation of a massage device (100) according to one embodiment of the present disclosure.

FIG. 9 is a block diagram of a massage device according to one embodiment of the present disclosure.

### BEST MODE OF THE INVENTION

A massage device includes an energy storage unit configured to store electrical energy supplied from a power supply unit, an input unit configured to receive an input from a user when supply of the electrical energy from the power supply unit is cut off, a back angle actuator which receives the electrical energy from the energy storage unit based on the input unit and moves a body massage unit such that the massage device is in an initial state, and a leg angle actuator which receives the electrical energy from the energy storage unit based on the input unit and moves a leg massage unit such that the massage device is in the initial state.

### [Modes of the Invention]

The advantages and features of the disclosed embodiments and methods for accomplishing the same will be more clearly understood from embodiments to be described below with reference to the accompanying drawings. However, the present disclosure is not limited to the following embodiments but may be implemented in various different forms. The embodiments are provided only to complete the present disclosure and to fully provide the scope of the present disclosure to a person having ordinary skill in the art to which the present disclosure pertains.

Terms used in the present specification will be briefly described, and then the disclosed embodiments will be described in detail.

The terms used in the present specification have been selected from general terms widely used in the art in consideration functions of the present disclosure, and the terms may be changed depending on the intention or convention of those skilled in the art or the introduction of new technology. Also, in specific cases, terms may be arbitrarily defined by an applicant, but their meaning will be described in detail in the detailed description of the present disclosure. Therefore, the terms used in the present specification should be construed based on the overall content of the present disclosure together with the actual meanings of the terms rather than their simple names or meanings

In the present specification, a singular expression may include a plural expression unless otherwise stated in context. In addition, a plural expression may include a singular expression unless otherwise stated in context.

Throughout the specification of the present disclosure, when it is assumed that a certain part includes a certain component, the term “comprising” or “including” means that a corresponding component may further include other components unless a specific meaning opposed to the corresponding component is written.

In addition, the term “unit” used in the present disclosure includes software components or hardware components to perform certain tasks. However, the term “unit” is not limited to software or hardware. A “unit” may be configured to reside in an addressable storage medium and configured to operate one or more processors. Thus, a “unit” may include, by way of example, components such as software components, object-oriented software components, class components and task components, processes, functions, attributes, procedures, subroutines, segments of program code, drivers, firmware, microcode, circuitry, data, databases, database structures, tables, arrays, and parameters. The functionality provided in the components and “units” may be combined into fewer components and “units” or further separated into additional components and units.

According to one embodiment of the present disclosure, a “unit” may be implemented as a processor and a memory. The term “processor” should be interpreted broadly to include a general-purpose processor, a central processing unit (CPU), a microprocessor, a digital signal processor (DSP), a controller, a microcontroller, a state machine, and the like. In some environments, a “processor” may be an application specific integrated circuit (ASIC), a programmable logic device (PLD), a field programmable gate array (FPGA), and the like. The term “processor” may also be a combination of processing devices, for example, a combination of a DSP and a microprocessor, a combination of a plurality of microprocessors, a combination of one or more microprocessors connected to a DSP core, or a combination of other arbitrary constituent elements.

The term “memory” should be interpreted broadly to include any electronic component capable of storing electronic information. The term “memory” may be various types of processor-readable media such as a random access memory (RAM), a read-only memory (ROM), a non-volatile random access memory (NVRAM), a programmable read-only memory (PROM), an erasable programmable read-only memory (EPROM), an electrically erasable PROM (EEPROM), a flash memory, a magnetic or optical data storage, registers, and the like. When the processor can read information from the memory and/or can write information in the memory, the memory is referred to as being in an electronic communication state with the processor. The memory integrated into the processor is in an electronic communication state with the processor.

In the present specification, an actuator is a component capable of providing a driving force. For example, the actuator may include a motor, a linear motor, an electronic motor, a direct current (DC) motor, an alternating current (AC) motor, a linear actuator, an electric actuator, and the like, but the present disclosure is not limited thereto.

In the present specification, according to one embodiment, a massage device may be a massage device including a body massage unit and a leg massage unit. In addition, according to another embodiment, a body massage unit 2100 and a leg massage unit 2300 may be present as separate independent devices (for example, a body massage device and a leg massage device), and a massage device may be a body massage device or a leg massage device.

Hereinafter, embodiments will be described in detail with reference to the accompanying drawings so that those skilled in the art to which the present disclosure pertains may easily practice the disclosure. A portion of drawings which is not related to the description will be omitted to clearly describe the present disclosure.

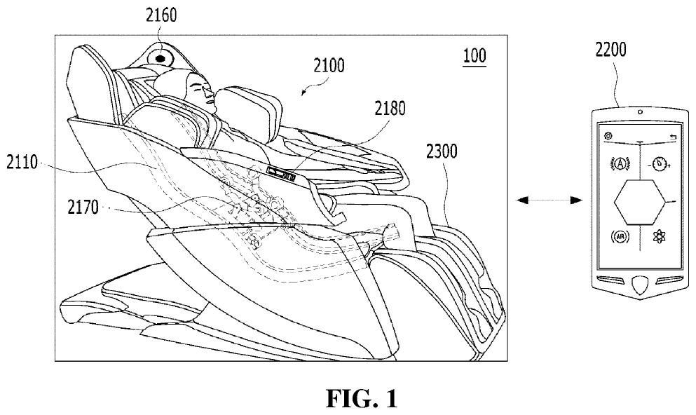

FIG. 1 shows diagrams for describing a massage device according to one embodiment of the present disclosure.

A massage device 100 according to one embodiment of the present disclosure may include a body massage unit 2100 which forms an area for accommodating at least a part of the body of a user and massages the body of the user and a leg massage unit 2300 which massages the legs of the user.

The body massage unit 2100 may provide a massage to at least a part of the body of a user. The body massage unit 2100 may include a massage module 2170 which provides a massage function to at least a part of the body of the user, an audio output module 2160 which provides any type of an audio output to the user, a main frame 2110 which constitutes a frame of the body massage unit 2100, and a user input unit 2180 which receives any type of an input from the user.

The above-described components included in the body massage unit 2100 are merely embodiments, and the body massage unit 2100 may include various components in addition to the above-described components.

In addition, the shape and structure of the massage device 100 shown in FIG. 1 are merely examples, and various types of massage device 100 may also be included within the scope of the present disclosure as long as the various types of massage device 100 do not depart from the scope of rights defined by the claims of the present disclosure.

The body massage unit 2100 may form a space with any shape for accommodating a user. The body massage unit 2100 may have a space having a shape corresponding to a shape of the body of the user. For example, as shown in FIG. 1, the body massage unit 2100 may be implemented as a sitting type capable of accommodating a part or entirety of the body of the user.

A portion of the body massage unit 2100 in contact with a ground surface may include any material for increasing a frictional force or any member (for example, a non-slip pad) for increasing a frictional force and may include wheels for enhancing the mobility of the massage device 100.

At least a portion of the body massage unit 2100 may move in a sliding manner. For example, when the body massage unit 2100 starts a massage, at least a portion of the body massage unit 2100 may move forward in the sliding manner. In addition, the body massage unit 2100 may be inclined backward. As a result, the body massage unit 2100 may provide a massage in a state of being inclined backward.

According to one embodiment of the present disclosure, the massage device 100 may include one or more air cells (not shown). The air cells may be positioned at a shoulder part and a pelvic part of a user and in an arm massage unit, the leg massage unit 2300, and the like. However, the present disclosure is not limited thereto, and the air cells may be disposed in various parts of the massage device 100.

The massage device 100 may include an air supply unit, and the air supply unit may inflate the air cell by supplying air to the air cell. The air supply unit may be positioned inside the body massage unit 2100 and may be positioned in the leg massage unit 2300. In addition, the air supply unit may be positioned outside the massage device 100.

The leg massage unit 2300 may provide a leg massage to a user. For example, the leg massage unit 2300 may include a calf massage unit which massages a calf of the user and/or a foot massage unit which massages a foot of the user.

A length of the leg massage unit 2300 may be adjusted according to body characteristics of a user. For example, when a tall user uses the massage device 100, since a calf of the user is long, the length of the leg massage unit 2300 needs to be increased. In addition, when a short user uses the massage device 100, since a calf of the user is short, the length of the leg massage unit 2300 needs to be decreased. Accordingly, the leg massage unit 2300 may provide a leg massage customized to a height of a user.

The massage module 2170 may be provided inside the body massage unit 2100 to provide any type of mechanical stimulation to a user accommodated in the body massage unit 2100. As shown in FIG. 1, the massage module 2170 may move along the main frame 2110 provided in the body massage unit 2100.

For example, the main frame 2110 of the body massage unit 2100 may include a rack gear, and the massage module 2170 moves along the rack gear to provide mechanical stimulation to various parts of the body of a user. The massage module 2170 may include a ball massage unit or a roller massage unit, but the present disclosure is not limited thereto.

The main frame 2110 constitutes a frame of an internal configuration of the body massage unit 2100 and may be implemented using a metal material or a plastic material. For example, the main frame 2110 may be implemented using iron, an alloy, steel, or the like. However, the present disclosure is not limited thereto, and the main frame 2110 may be implemented using various hard materials.

According to one embodiment of the present disclosure, the massage device 100 may include an audio output module 2160. The audio output module 2160 may be provided at any of various positions. For example, the audio output module 2160 may include a plurality of output units such as an upper audio output unit disposed at an upper end portion of a seat unit in contact with a user, a front audio output unit attached to a front end portion of a left/right arm massage unit of the seat unit, and/or a rear audio output unit attached to a rear end portion of the arm massage unit, but the present disclosure is not limited thereto. In this case, the audio output module 2160 may provide a stereophonic sound with a 5.1 channel or the like, but the present disclosure is not limited thereto.

According to one embodiment of the present disclosure, a user may control the massage device 100 using a massage device control device 2200. The massage device control device 2200 may be connected to the massage device 100 through wired communication and/or wireless communication.

The massage device control device 2200 may include a remote controller, a cellular phone, a personal digital assistant (PDA), or the like. However, the present disclosure is not limited thereto, and the massage device control device 2200 may include various electronic devices that are connectable to the massage device 100 through wired or wireless communication.

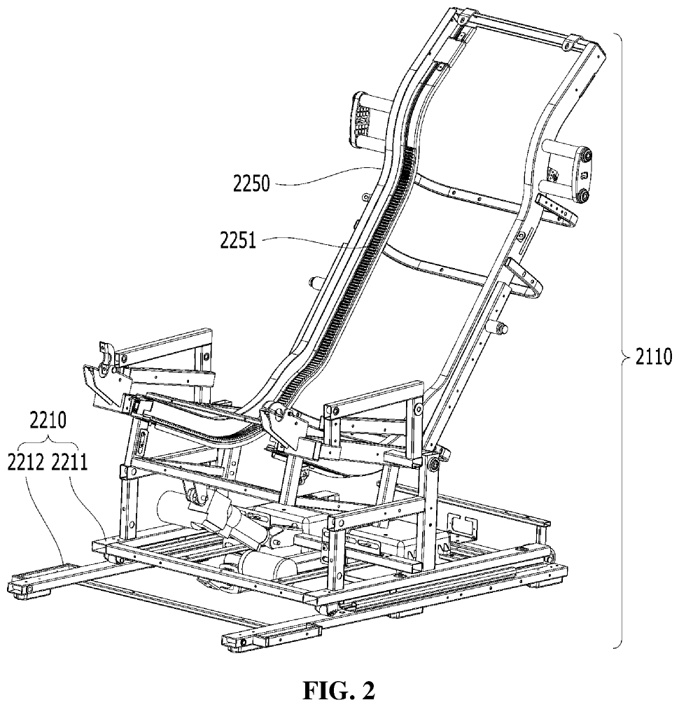

FIG. 2 is a diagram for describing a main frame according to one embodiment of the present disclosure.

According to one embodiment of the present disclosure, a main frame 2110 may include an upper frame 2250 provided with a massage module 2170 and a base frame 2210 supporting the upper frame 2250.

Rack gears 2251 may be provided on at least portions of the upper frame 2250. The rack gear 2251 may be a member for guiding the vertical movement of the body massage module 2170 and may include a plurality of valleys and a plurality of peaks.

According to one embodiment of the present disclosure, the rack gears 2251 may be provided in forms facing each other at both sides of the upper frame 2250, and the body massage module 2170 may move along the rack gears 2251.

In FIG. 2, the rack gear 2251 is formed in a vertical direction, but the present disclosure is not limited thereto. The rack gear 2251 may include a rack gear in a front-rear direction and a rack gear in the vertical direction. In the present disclosure, the front-rear direction may be a direction from the body massage module 2170 toward a user or a direction from the user toward the body massage module 2170 and may also be referred to as a Z-axis direction.

The body massage module 2170 may include gears engaged with the rack gears 2251. More specifically, the body massage module 2170 may include gears engaged with the rack gear in the front-rear direction and the rack gear in the vertical direction. As the gear is rotated by an actuator provided in the body massage module 2170, the body massage module 2170 may move forward, backward, upward, or downward.

As the body massage module 2170 moves forward, an intensity of a massage may increase. In addition, as the body massage module 2170 moves backward, an intensity of a massage may decrease.

The rack gear 2251 may be implemented using a metal material or a plastic material. For example, the rack gear 2251 may be implemented using iron, steel, an alloy, reinforced plastic, a melamine resin, a phenol resin, or the like, but the present disclosure is not limited thereto.

The upper frame 2250 may be implemented in various shapes. For example, the upper frame 2250 may be divided into an S frame, an L frame, an S&L frame, and a double S&L frame according to a shape, but the present disclosure not limited thereto.

The S frame is a frame that includes a shape in which at least a portion of the upper frame 2250 is curved like “S.” The L frame is a frame that includes a shape in which at least a portion of the upper frame 2250 is bent like “L.” The S&L frame is a frame that includes both a curved shape like “S” and a bent shape like “L.” The double S&L is a frame that includes a bent shape like “L” and a shape in which two portions are curved like “S.”

The base frame 2210 supports the upper frame 2250 of the main frame 2110 and is a section in contact with a ground surface. The base frame 2210 may include a base upper frame 2211 and a base lower frame 2212.

The base upper frame 2211 may support the upper frame 2250, and the base lower frame 2212 may be in contact with a ground surface. In addition, the base upper frame 2211 may be positioned in contact with the base lower frame 212.

According to one embodiment of the present disclosure, the base upper frame 2211 may move along the base lower frame 2212. For example, the base upper frame 2211 may move forward or backward along the base lower frame 2212 in the sliding manner. In this case, the upper frame 2250 may be connected to the base upper frame 2211 to move according to the movement of the base upper frame 2211.

For example, the upper frame 2250 may also move forward along when the base upper frame 2211 moves forward, and the upper frame 2250 may also move backward along when the base upper frame 2211 moves backward. Thus, the body massage unit 2100 may be allowed to move in the sliding manner.

Specifically, in order to allow movement of the base upper frame 2211, a moving wheel may be provided under the base upper frame 2211. In addition, a guide member capable of guiding the moving wheel may be provided on the base lower frame 2212. The moving wheel provided on the base upper frame 2211 may be moved along the guide member provided in the base lower frame 2212 to allow the base upper frame 2211 to move forward or backward.

According to another embodiment of the present disclosure, the massage device 100 may not provide a sliding function, and in this case, the base frame 2210 may not be separated into the upper frame and the lower frame.

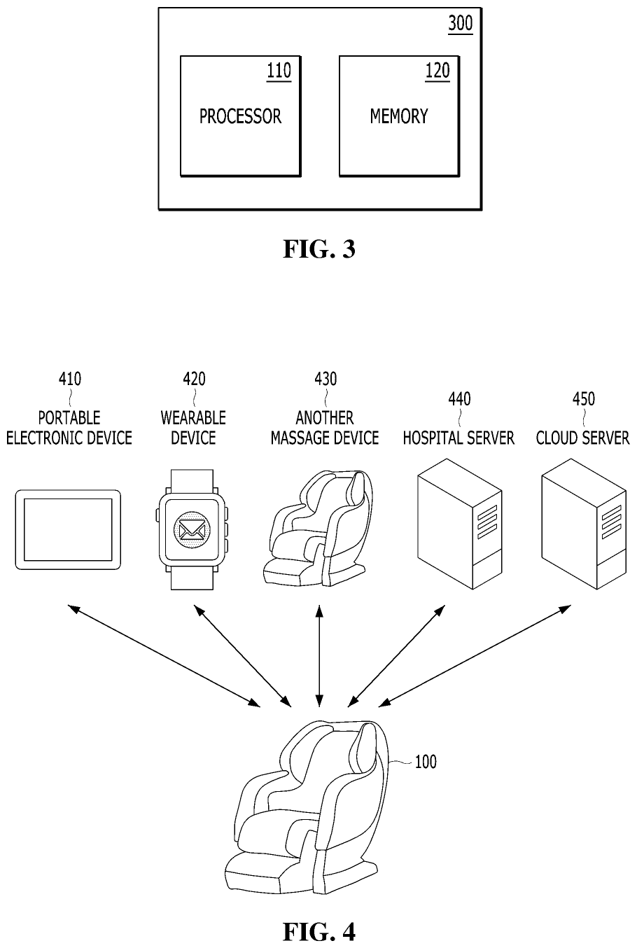

FIG. 3 is a diagram illustrating a massage device according to one embodiment of the present disclosure.

A massage device 100 may include a controller 300 which controls the operation of the massage device 100. The controller 300 may include a processor 110 and a memory 120. The processor 110 may execute commands stored in the memory 120.

The processor 110 may control the operation of the massage device 100. The massage device 100 may include one processor and may include a plurality of processors. When the massage device 100 includes the plurality of processors, at least some of the plurality of processors may be positioned at physically separated distances. In addition, the present disclosure is not limited thereto, and the massage device 100 may be implemented in various ways.

According to one embodiment of the present disclosure, the processor 110 may control the operation of the massage device 100. For example, the massage device 100 may include a plurality of actuators, and the massage device 100 may control the operation of the massage device 100 by controlling the operation of the plurality of actuators. For example, the massage device 100 may include at least one of a driving unit for moving an armrest frame support unit, an actuator for moving a massage module 2170, at least one actuator included in the massage module, a back angle actuator, a leg angle actuator, a foot massage actuator, a leg length adjustment actuator, and a sliding actuator. The processor 110 may control the operation of the massage device 100 by controlling the actuators.

The actuator for moving the massage module may be an actuator that may perform vertical movement of the massage module 2170, and the massage module 2170 may move along the rack gear by the operation of the actuator for moving the massage module 2170.

The back angle actuator may be an actuator which adjusts an angle of a portion of the massage device 100 with which the back of a user is in contact, and a back angle of the massage device 100 may be adjusted by the operation of the back angle actuator.

The leg angle actuator may be an actuator which adjusts an angle of a leg massage unit 2300 of the massage device 100, and an angle between the leg massage unit 2300 and a body massage unit 2100 may be adjusted by the operation of the leg angle actuator.

The foot massage actuator is an actuator which operates a foot massage module included in the leg massage unit 2300. By using the foot massage actuator, the massage device 100 may provide a foot massage to a user.

One or more actuators may be included in the massage module 2170, and the processor 110 may provide various massage operations by operating the one or more actuators. For example, the processor 110 may provide a tapping massage, a kneading massage, and the like by operating the one or more actuators included in the massage module 2170. However, the present disclosure is not limited thereto, and the processor 110 may provide various massage operations.

The leg length adjustment actuator is an actuator which adjusts a length of the leg massage unit 2300. For example, by using the leg length adjusting actuator, the processor 110 may adjust the length of the leg massage unit 2300 to suit a user, and as a result, the user may receive a massage suitable for a body type.

The sliding actuator may perform a sliding operation of the massage device 100. For example, a horizontal base upper frame may move forward or backward by the operation of the sliding actuator, and as a result, an upper frame connected to the horizontal base upper frame may also move forward or backward.

The memory 120 may store various types of information related to the massage device 100. For example, the memory 120 may include massage control information and may include personal authentication information, but the present disclosure is not limited thereto.

The memory 120 may be implemented through a non-volatile storage medium capable of continuously storing any data. For example, the memory 120 may include a storage device based on a flash memory and/or a battery-backup memory in addition to a disk, an optical disc, and a magneto-optical storage device, but the present disclosure is not limited thereto.

The massage device 100 may include a sensor unit. The sensor unit may acquire various types of information using at least one sensor. The sensor unit may be provided as a sensor using a portion for measuring pressure, potential, optics, and the like. For example, the sensor may include a pressure sensor, an infrared sensor, a light-emitting diode (LED) sensor, a touch sensor, and the like, but the present disclosure is not limited thereto.

In addition, the sensor unit may include a biometrics acquisition sensor. The biometrics acquisition sensor may acquire fingerprint information, face information, voice information, iris information, weight information, electrocardiogram information, body composition information, and the like. However, the present is not limited thereto, and the biometrics acquisition sensor may acquire various types of biometric information.

According to another embodiment of the present disclosure, the massage device 100 may detect a contact area and/or a contact position with a user through the sensors. In addition, the massage device 100 may provide a customized massage based on information acquired through the sensors. In addition, the massage device 100 may include a communication unit. The communication unit of the massage device 100 may receive a signal to an external device. The processor 110 may obtain a result signal by processing the received signal. The communication unit may output the result signal to the external device.

The communication unit may communicate with a module inside the massage device 100, an external massage device, and/or a user terminal 2200 through any type of network. The communication unit may include a wired/wireless connection module for network connection. As a wireless connection technology, for example, wireless local area network (WLAN), Wi-Fi, wireless broadband (WiBro), world interoperability for microwave access (WiMAX), high speed downlink packet access (HSDPA), or the like may be used. As a wired connection technology, for example, x digital subscriber line (xDSL), fibers to the home (FTTH), power line communication (PLC), or the like may be used. In addition, a network connection unit may include a short-range communication module to transmit or receive data to or from any device/terminal positioned at a short distance. For example, as a short range communication technology, Bluetooth, radio frequency identification (RFID), infrared data association (IrDA), ultra wideband (UWB), ZigBee, or the like may be used, but the present disclosure is not limited thereto.

In addition, the massage device 100 may further include an input unit or an output unit. The massage device 100 may receive an input from a user using the input unit. In addition, the massage device 100 may output a processing result of the processor 110 to the output unit.

Specifically, the input unit may receive a command related to control of the operation of the massage device 100 from a user, and the input unit 2180 may be implemented in various forms. For example, the input unit 2180 may be provided in the body massage unit 2100 or the leg massage unit 2300, but the present disclosure is not limited thereto.

The massage device 100 may obtain various commands from a user through the input unit 2180. For example, the massage device 100 may receive any command related to selection of a massage module, selection of a massage type, selection of a massage intensity, selection of a massage time, selection of a massage part, selection of a position and an operation of the body massage unit 2100, selection of turning-on/off of the massage device 100, selection of whether to operate a warming function, selection related to reproducing a sound source, or the like, but the present disclosure is not limited thereto.

The massage device 100 may provide an interface for selecting a massage mode. For example, the input unit 2180 or the output unit may include a massage device control device 2200. Various medical massage modes related to body improvement may be listed through the massage device control device 2200.

The medical massage modes may include at least one of a concentration mode, a meditation mode, a recovery mode, a stretching mode, a sleeping mode, a vitality mode, a golf mode, a hip-up mode, an examinee mode, a weightless mode, and a growth mode.

According to another embodiment of the present disclosure, the user input unit 2180 may include hot-key type buttons, a selection button for implementing selection, cancellation, or input of a direction, and/or the like according to a preset user setting function, an autonomously preset function, or the like.

The input unit 2180 may be implemented using a key pad, a dome switch, a (static pressure/static electricity) touch pad, a jog wheel, a jog switch, or the like, but the present disclosure is not limited thereto. In addition, the input unit 2180 may acquire a command through an utterance of a user based on a voice recognition technology.

According to one embodiment of the present disclosure, the output unit may include a display configured to display an operation state of the massage device 100, a current state of a user, or the like. In this case, the display may include at least one of a liquid crystal display (LCD), a thin film transistor LCD (TFT LCD), an organic light-emitting diode (OLED), a flexible display, and a three-dimensional (3D) display, but the present disclosure is not limited thereto.

The output unit may include an audio output module 2160. The audio output module 2160 may provide any type of audio output to a user. For example, the audio output module 2160 may provide brain stimulation to a user by outputting a sound source and/or a binaural beat optimized to a massage pattern provided by the massage device 100 to the user. The audio output module 2160 may output a sound signal that is received through a network (not shown) or stored in an internal/external storage medium (not shown). For example, the audio output module 2160 may output a sound source under control of the user terminal 2200 through a network connection (for example, a Bluetooth connection) with the user terminal 2200. In addition, the audio output module 2160 may output any type of sound signal generated in relation to the operation of the massage device 100.

It may be well understood by those skilled in the art that the present disclosure may be implemented by coupling other program modules and/or a combination of hardware and software. For example, the present disclosure may be implemented by a computer-readable medium.

Any computer-accessible medium may be the computer-readable medium, and the computer-readable medium includes a volatile or nonvolatile medium, a transitory or non-transitory medium, and a portable or non-portable medium. As a nonrestrictive example, the computer-readable medium may include a computer-readable storage medium or a computer-readable transmission medium.

The computer-readable storage medium may include a volatile or nonvolatile medium, a transitory or non-transitory medium, and a portable and non-portable medium which is implemented by any method or technique of storing information such as a computer-readable command, a data structure, a program module, or other types of data. The computer-readable storage medium includes a RAM, a ROM, an EEPROM, a flash memory, or other memory technologies, a compact disc-ROM (CD-ROM), a digital video disk (DVD), or other optical disk storage devices, a magnetic cassette, magnetic tape, a magnetic disk storage device, or other magnetic storage devices, or any other media which are accessible by a computer and used for storing desired information, but the present disclosure is not limited thereto.

FIG. 4 shows diagrams illustrating an external device capable of communicating with a massage device 100 according to one embodiment of the present disclosure.

The massage device 100 may communicate with the external device in a wired or wireless manner and may transmit/receive various types of data.

The external device may include an artificial intelligence (AI) speaker or a portable electronic device 410 such as a tablet personnel computer or a smartphone. The portable electronic device 410 may be dedicated to the massage device 100 or may be a general-purpose portable electronic device. In addition, the external device may include a wearable device 420 such as a smart watch or a smart band. The external device may include a massage device 430 rather than the massage device 100 currently used for a user. The external device may include a hospital server 440. The external device may include a personal health record (PHR) server. In addition, the external device may include a cloud server 450. The external device may include a medical measurement device such as an electronic weighing machine, a blood glucose meter, or a blood pressure meter.

Although some examples of the external devices have been described in the present disclosure, it should be understood that any device capable of communicating with the massage device 100 in a wired or wireless manner and exchanging information with the massage device 100 may be included in the external device.

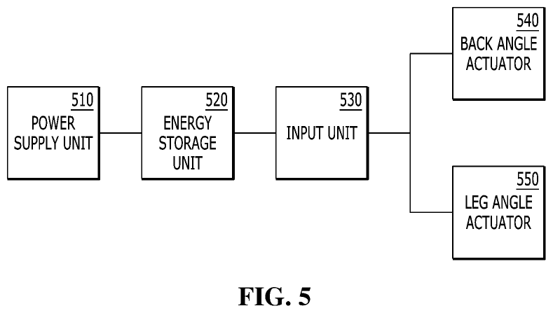

FIG. 5 is a block diagram of a massage device according to one embodiment of the present disclosure.

A massage device 100 may include an energy storage unit 520 which stores electrical energy supplied from a power supply unit 510. The energy storage unit 520 may include a super capacitor or a battery. The energy storage unit 520 may store electrical energy supplied from the power supply unit 510. However, the present disclosure is not limited thereto, and energy may be supplied from an auxiliary power supply unit. The auxiliary power supply unit may include a generator, and the generator may include a solar generator, a generator configured to convert kinetic energy into electrical energy, and the like. The energy storage unit 520 may store energy capable of operating at least one of actuators included in the massage device 100 within a few minutes.

The massage device 100 may include an input unit 530 which receives an input from a user when the supply of electrical energy from the power supply unit is cut off. The input unit 530 may be implemented as a separate circuit from the input unit 2180 of FIG. 1. For example, the input unit 2180 of FIG. 1 may receive electrical energy from the power supply unit 510. However, the input unit 530 may receive electrical energy from the energy storage unit 520. Accordingly, when an abnormality occurs in the power supply unit 510 and energy is not supplied from the power supply unit 510, the input unit 2180 may not operate. However, the input unit 530 may operate even when the power supply unit 510 is abnormal.

The input unit 530 may be a button for setting the massage device 100 to a specific posture when an abnormality occurs or does not occur in the power supply unit 510. The specific posture may be a posture at which a user easily stands up from the massage device 100. The specific posture may be a preset posture. The specific posture may include an initial state of the massage device 100.

The massage device 100 may include a back angle actuator 540 or a leg angle actuator 550.

The back angle actuator 540 may receive electrical energy from the energy storage unit 520 based on the input unit 530. Also, the back angle actuator 540 may use the received electrical energy to move a body massage unit 2100 such that the massage device 100 is in an initial state.

In addition, the leg angle actuator 550 may receive electrical energy from the energy storage unit 520 based on the input unit 530. Also, the leg angle actuator 550 may move a leg massage unit 2300 such that the massage device 100 is in the initial state.

The initial state of the massage device 100 may be a state in which the massage device 100 is not laid down. In addition, the initial state may be a state in which a user may comfortably sit on the massage device 100 and stand up therefrom. The initial state may be preset. For example, the initial state may be a state in which the body massage unit 2100 is relatively perpendicular to a ground surface. Also, the initial state may be a state in which the leg massage unit 2300 bends the knee of a user. In addition, the initial state may be a state in which a length of the leg massage unit 2300 is the shortest.

At least one actuator may include a portion for identifying an initial state. For example, at least one actuator may include a sensor capable of measuring a rotation angle. The massage device 100 may control at least one actuator to return to an initial position by rotating the at least one actuator reversely as much as the at least one actuator has already rotated. The control may be implemented by an electrical circuit or a processor. When the actuator is at the initial position, the massage device 100 may be in the initial state.

In addition, the massage device 100 may include a sensor capable of identifying the initial position of the at least one actuator. The massage device 100 may control the at least one actuator to rotate until the at least one actuator returns to the initial position. The control may be implemented by an electrical circuit or a processor.

In addition, the massage device 100 may not include a portion for identifying the initial position of the at least one actuator. The massage device 100 may rotate the at least one actuator based on a user input. The at least one actuator may rotate in one direction. In addition, the at least one actuator may not rotate due to the jamming between mechanical parts included in the massage device 100. When the at least one actuator is no longer rotated, the massage device 100 may be in the initial state.

In addition, when a load applied to the at least one actuator is greater than or equal to a threshold value, the massage device 100 may cut off the supply of power to the at least one actuator from the energy storage unit 520. This may be implemented by a mechanical/electronic fuse, a solenoid coil, or a microprocessor. According to the present disclosure, it is possible to prevent a problem that may occur due to a great load applied to the actuator or a failure that may occur due to a great load applied to the mechanical parts of the massage device 100.

The input unit 530 may receive an input from a user. For example, the input unit 530 may be a switch. When a user presses the input unit 530, a connection occurs between the energy storage unit 520 and the at least one actuator, and thus electrical energy of the energy storage unit 520 may be supplied to the at least one actuator. The at least one actuator may move the massage device 100 to enter an initial state. When a user does not press the input unit 530, electrical energy from the energy storage unit 520 may not be supplied to the at least one actuator.

In addition, whether the input unit 530 is pressed may be indicated using an electrical signal. For example, when the input unit 530 is pressed, a signal indicating “ON” may be output. In addition, when the input unit 530 is not pressed, a signal indicating “OFF” may be output. However, the present disclosure is not limited thereto, and when the input unit 530 is not pressed, a signal indicating “ON” may be output. In addition, when the input unit 530 is pressed, a signal indicating “OFF” may be output.

When a signal of the input unit 530 indicates “ON,” an electrical circuit included in the massage device 100 may supply electrical energy of the energy storage unit 520 to the at least one actuator. In addition, when a signal of the input unit 530 indicates “OFF,” the electrical circuit included in the massage device 100 may not supply electrical energy of the energy storage unit 520 to the at least one actuator.

Even when a problem occurs in the power supply unit 510, the energy storage unit 520 may supply electrical energy to the at least one actuator. A situation in which an abnormality occurs in the power supply unit 510 means a situation in which electrical energy is not supplied to the massage device 100 from the power supply unit 510. For example, the situation may include a situation in which the power supply unit 510 does not operate due to a power outage, disconnection, or power cord disconnection or a situation in which the power supply unit 510 does not operate due to an abnormality in a circuit of the power supply unit 510.

When the supply of electrical energy from the power supply unit 510 is cut off, based on the input unit 530, electrical energy from the energy storage unit may be supplied to at least one of the back angle actuator 540 and the leg angle actuator 550. When the supply of electrical energy from the power supply unit 510 is cut off, at least one of the back angle actuator 540 and the leg angle actuator 550 may receive electrical energy from the energy storage unit 520.

Specifically, when an abnormality occurs in the power supply unit 510, the input unit 530 may receive an input from a user. Based on the input unit 530, the back angle actuator 540 and the leg angle actuator 550 may operate simultaneously to set the massage device 100 to enter an initial state. In the massage device 100, since only the back angle actuator 540 and the leg angle actuator 550 operate when an abnormality occurs in the power supply unit 510, energy of the energy storage unit 520 can be efficiently used, and also, the massage device 100 can return to a state in which a user can easily stand up therefrom.

In addition, when the supply of electrical energy from the power supply unit 510 is cut off, based on the input unit 530, only at least one of the back angle actuator 540 and the leg angle actuator 550 may be operated. For example, when the supply of electrical energy from the power supply unit 510 is cut off, the back angle actuator 540 may be in an initial state or may be at a position at which a user can easily stand up from the massage device 100. That is, the body massage unit 2100 may be in an initial state or may be in a state close to the initial state. In this case, the energy storage unit 520 may supply electrical energy only to the leg angle actuator 550. Therefore, the massage device 100 may set the leg massage unit 2300 to enter an initial state.

Although a case in which the energy storage unit 520 supplies electrical energy only to the leg angle actuator 550 has been described above, the energy storage unit 520 may supply electrical energy only to the back angle actuator 540. Since a case in which electrical energy is supplied only to the back angle actuator 540 is similar to a case in which electrical energy is supplied only to the leg angle actuator 550, redundant descriptions will be omitted.

According to the present disclosure, the massage device 100 may use minimum energy from the energy storage unit 520 to return to an initial state in which a user easily stands up from the massage device 100.

The rotation position of the back angle actuator 540 or the position of the body massage unit 2100, at which a user easily stands up from the massage device 100, may be preset. As described above, the rotation position of the back angle actuator 540 or the position of the body massage unit 2100 may be measured by a sensor included in the actuator or a sensor included in the massage device 100. When the rotation position of the back angle actuator 540 or the position of the body massage unit 2100 is within a certain range, the massage device 100 uses a circuit or a processor to control the position of the back angle actuator 540 or the body massage unit 2100 to not be changed.

In addition, when the supply of electrical energy from the power supply unit 510 is cut off, the leg angle actuator 550 may be in an initial state or may be at a position at which a user easily stands up from the massage device 100. That is, the leg massage unit 2300 may be in an initial state or in a state close to the initial state. In this case, the energy storage unit 520 may supply electrical energy only to the back angle actuator 540. Therefore, the massage device 100 may set the body massage unit 2100 to enter an initial state. According to the present disclosure, the massage device 100 may use minimum energy from the energy storage unit 520 to return to an initial state in which a user easily stands up from the massage device 100.

The rotation position of the leg angle actuator 550 or the position of the leg massage unit 2300, at which a user easily stands up from the massage device 100, may be preset. As described above, the rotation position of the leg angle actuator 550 or the position of the leg massage unit 2300 may be measured by the sensor included in the actuator or the sensor included in the massage device 100. When the rotation position of the leg angle actuator 550 or the position of the leg massage unit 2300 is within a certain range, the massage device 100 uses the circuit or processor to control the position of the leg angle actuator 550 or the leg massage unit 2300 to not be changed.

As described above, the actuator may include, for example, a motor, and a rotation position may indicate an angle at which the actuator rotates from an initial state.

In addition, the massage device 100 may increase or decrease a length of the leg massage unit 2300 according to a body type of a user. In order to increase or decrease the length of the leg massage unit 2300, the massage device 100 may include an actuator different from the leg angle actuator 550. The initial state of the massage device 100 may be a state in which a length of the leg massage unit 2300 decreases to a minimum.

When a massage is in progress, the leg massage unit 2300 may be in a state in which a length thereof increases. When the electrical energy supply of the power supply unit 510 is cut off, the massage device 100 does not operate an actuator for increasing or decreasing the length of the leg massage unit 2300 in order to minimally consume the energy of the energy storage unit 520. By using the leg angle actuator 550, the massage device 100 may control the leg massage unit 2300 to move only until the leg massage unit 2300 comes into contact with a ground surface. That is, the massage device 100 may not return to an initial state and may return to a state in which a user easily stands up from the massage device 100.

More specifically, when the leg massage unit 2300 comes into contact with the ground surface, the leg massage unit 2300 is caught on the ground surface, and thus the leg angle actuator 550 may be no longer rotated. The massage device 100 may stop the rotation of the leg angle actuator 550. Since a process of controlling the leg angle actuator 550 to stop rotation has already been described, redundant descriptions will be omitted.

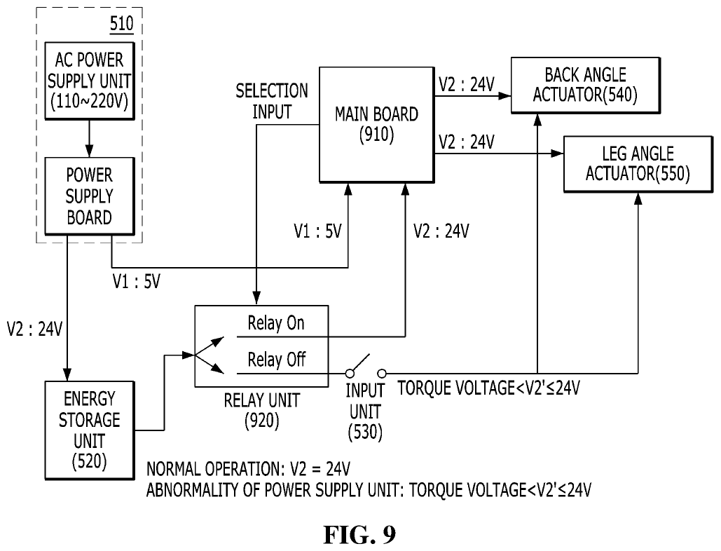

FIG. 9 is a block diagram of a massage device according to one embodiment of the present disclosure.

FIG. 9 is a diagram for describing the massage device of FIG. 5 in more detail.

An operation when a power supply unit 510 operates normally will be described first. The power supply unit 510 may include an AC power supply or a power supply board. The power supply board may include a switching multi-power supply (SMPS). The power supply unit 510 may convert applied AC power into a relatively high voltage V2 (for example, 24 V) and a relatively low voltage V1 (for example, 5 V). The voltages V1 and V2 may be DC voltages. The voltage V1 converted by the power supply unit 510 may be supplied to a main board 910 as system power to operate the main board.

The voltage V2 converted by the power supply unit 510 may charge an energy storage unit 520. Also, the power supply unit 510 may output the voltage V2 to a relay unit 920. According to one embodiment of the present disclosure, the power supply unit 510 may transmit the voltage V2 to the relay unit 920 through the energy storage unit 520. According to another embodiment of the present disclosure, the power supply unit 510 may transmit the voltage V2 to the relay unit 920 except through the energy storage unit 520.

The main board activated by receiving the voltage V1 may control the relay unit 920 to enter a relay-on state. When the relay unit 920 is in a relay-on state, the relay unit 920 may transmit the voltage V2 to the main board 910. The main board 910 may supply the voltage V2 to at least one of a back angle actuator 540 and a leg angle actuator 550. The main board 910 may control the operation of at least one of the back angle actuator 540 and the leg angle actuator 550.

When the power supply unit 510 operates normally, since the relay unit 920 is in a relay-on state, an input unit 530 cannot control the back angle actuator 540 and the leg angle actuator 550. That is, the input unit 530 cannot control power supplied to the back angle actuator 540 and the leg angle actuator 550. Since the main board 910 receiving power from the power supply unit 510 can determine an emergency situation based on a sensor and take action on the emergency situation, the massage device 100 may operate safely.

Next, a case in which the power supply unit 510 does not operate normally will be described. The power supply unit 510 may not operate normally due to power cord disconnection, a power outage, or disconnection. When the voltage V1 is not supplied to the main board due to an abnormality in the power supply unit 510, the relay unit 920 may be in a relay-off state. At least one of the back angle actuator 540 and the leg angle actuator 550 may receive a voltage V2′ from the energy storage unit 520 based on the input unit 530. The voltage V2′ may be electrical energy supplied from the energy storage unit 520 and thus may be less than or equal to 24 V. In addition, the voltage V2′ may be greater than a torque voltage that is a minimum voltage sufficient for operating at least one of the back angle actuator 540 and the leg angle actuator 550.

In a case in which the power supply unit 510 does not operate normally, when a user presses the input unit 530, power may be supplied to at least one of the back angle actuator 540 and the leg angle actuator 550 by a mechanical switch. The input unit 530 may supply electrical energy with the voltage V2′ to at least one of the back angle actuator 540 and the leg angle actuator 550 to operate at least one of the back angle actuator 540 and the leg angle actuator 550. Accordingly, the massage device 100 may return to a specific posture at which a user easily stands up from the massage device 100.

While a user presses the input unit 530 and electrical energy from the energy storage unit 520 is transmitted to the back angle actuator 540, the back angle actuator 540 operates such that a backrest of the massage device 100 is erected.

In addition, while a user presses the input unit 530 and electrical energy from the energy storage unit 520 is transmitted to the leg angle actuator 550, the leg angle actuator 550 may operate such that a leg massage unit 2300 of the massage device 100 is lowered.

The massage device 100 may further include a seat angle actuator. The seat angle actuator may be an actuator for adjusting an angle of a seat on which a user sits. When a user presses the input unit 530, electrical energy from the energy storage unit 520 may be transmitted to the seat angle actuator. The seat angle actuator may be driven by electrical energy, and the massage device 100 may return to a posture at which a user easily stands up.

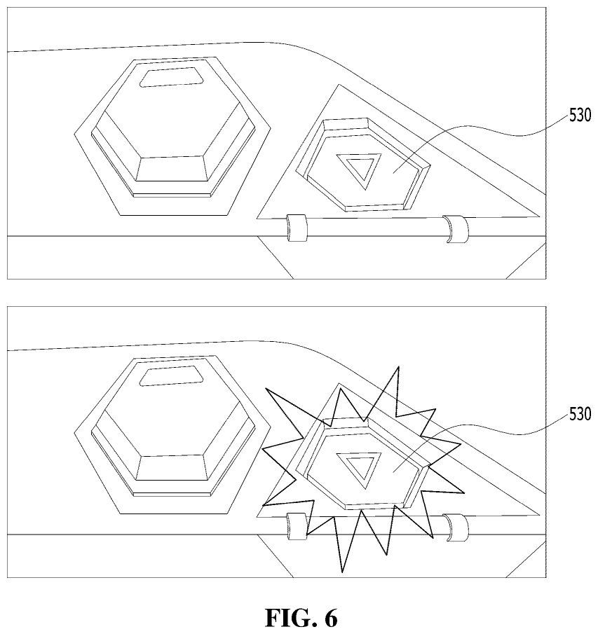

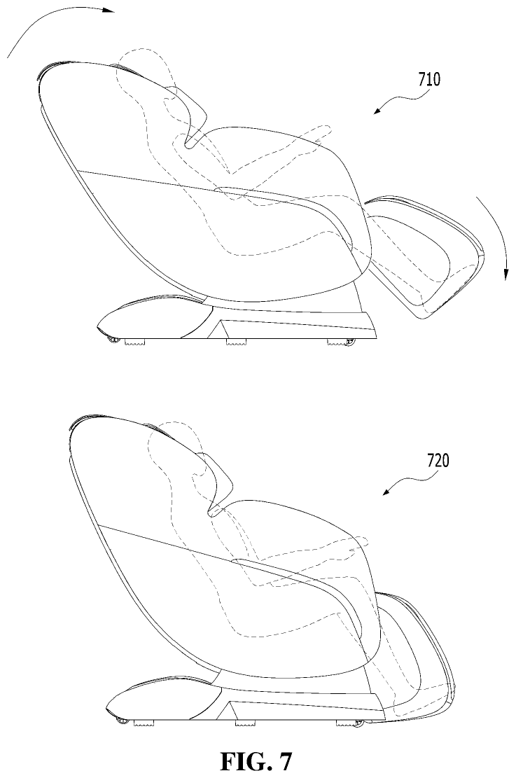

FIG. 6 illustrates an input unit 530 according to one embodiment of the present disclosure.

The input unit 530 may be positioned at a position at which a user conveniently presses the input unit 530 at any time. The input unit 530 may include a touch switch, a jog dial switch, a rotary switch, a toggle switch, a push button switch, a tact switch, a slide switch, or a tip switch. In addition, the input unit 530 may include a knob or a button and may allow a user to easily operate the button. The input unit 530 may include a light source. The light source may include a light bulb or an LED. When the supply of electrical energy from a power supply unit 510 is cut off, the light source included in the input unit 530 may flicker light for a predetermined time using electrical energy supplied to an energy storage unit 520.

A user can easily find the input unit 530 even in a dark environment due to a power outage. Therefore, even when a power outage occurs, the user may use the input unit 530 to set a massage device 100 to enter an initial state.

In addition, the light source may flicker light for a predetermined time, but the present disclosure is not limited thereto. The light source may emit light for a predetermined time. The massage device 100 may prevent energy of the energy storage unit 520 from being excessively consumed by allowing the light source to operate only for a predetermined time.

In addition, the massage device 100 may include a lantern. For example, in case of a power outage, since surroundings become dark, a user may collide with other objects when standing up from the massage device 100. Therefore, by using electrical energy of the energy storage unit 520, the lantern may illuminate the surroundings of the massage device 100 for a certain time. Since a user can identify what kind of object is around the massage device 100, it is possible to reduce a risk in which the user collides with an object.

FIG. 7 shows diagrams illustrating the operation of a massage device according to one embodiment of the present disclosure.

A state 710 of FIG. 7 may be a state in which a massage device 100 is providing a massage to a user. A body massage unit 2100 may be inclined so that the user may be in a lying position. In addition, a leg massage unit 2300 may be stretched such that the user stretches legs.

An input unit 530 may receive an input from a user. The input unit 530 may receive electrical energy from an energy storage unit 520 even when electrical energy is cut off from a power supply unit 510. Based on the input unit 530, the massage device 100 may move to enter an initial state. Specifically, based on the input unit 530, a back angle actuator 540 or a leg angle actuator 550 of the massage device 100 may receive electrical energy from the energy storage unit 520. A body massage unit 2100 may be moved by the back angle actuator 540 to have a specific posture. In addition, a leg massage unit 2300 may be moved by the leg angle actuator 550 to have a specific posture. The specific posture may be a posture at which a user easily stands up from the massage device 100. The specific posture may include an initial state of the massage device 100.

A state 720 of FIG. 7 may represent an initial state. The body massage unit 2100 may be in a state of being erected, and the leg massage unit 2300 may be in a state that allows the knee of a user to be bent. Since the massage device 100 enters a specific posture based on the input unit 530, a user can easily escape from the massage device 100 even when the user has mobility difficulties.

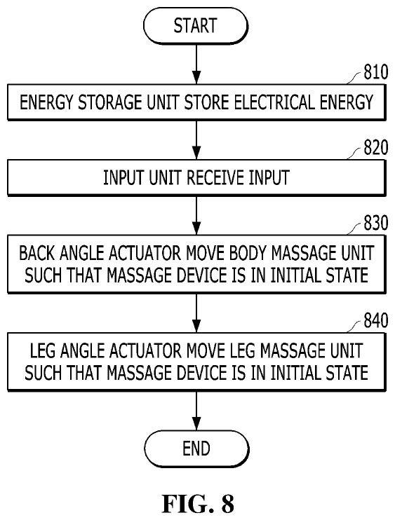

FIG. 8 is a diagram illustrating the operation of a massage device 100 according to one embodiment of the present disclosure.

As described with reference to FIG. 3, the massage device 100 may include a controller 300.

The controller 300 may operate using electrical energy supplied from a power supply unit 510 or an energy storage unit 520. The controller 300 may measure an amount of electrical energy remaining in the energy storage unit 520. The controller 300 may be a microprocessor including a sensor for measuring an amount of electrical energy remaining in the energy storage unit 520. Alternatively, the controller 300 may measure an amount of electrical energy remaining in the energy storage unit 520 using a separate sensor.

More specifically, when the energy storage unit 520 is a super capacitor, the controller 300 may measure a voltage to measure electrical energy remaining in the super capacitor. Electrical energy may be calculated as 1/2xCxV2, and in this case, C may denotes a capacitance of a capacitor, and V may denotes a measured voltage. The controller 300 may use electrical energy value itself or may use a value proportional to or positively correlated with the electrical energy value.

The controller 300 may include a low-power processor. When an abnormality occurs in the power supply unit 510, the controller 300 may be operated for at least 20 minutes by the energy storage unit 520. That is, even when an abnormality occurs in the power supply unit 510, the controller 300 may control the massage device 100 while a user escapes from the massage device 100.

The massage device 100 may further include a display unit. The display unit may be included in an output unit. Various devices included in the output unit may stop operating when not receiving electrical energy from the power supply unit 510. However, even when the display unit does not receive electrical energy from the power supply unit 510, the display unit included in the output unit may receive electrical energy from the energy storage unit 520.

The display unit may include a low-power element. For example, the display unit may include one or more low-power LEDs. The display unit may display an amount of electrical energy remaining in the energy storage unit 520 based on an amount of electrical energy remaining in the energy storage unit 520. For example, among the LEDs included in the display unit, the number of LEDs which emit light may be proportional to an amount of electrical energy remaining in the energy storage unit 520. In addition, an intensity of light of the LED included in the display unit may be proportional to an amount of electrical energy remaining in the energy storage unit 520.

In addition, the display unit may include a speaker. The number of times the speaker included in the display makes a beep sound may be proportional to an amount of electrical energy remaining in the energy storage unit 520.

The display unit may make sound or emit light only in a certain situation. For example, when the power supply unit 510 stops operating, the display unit may make sound or emit light to notify a user of an amount of electrical energy remaining in the energy storage unit 520. In addition, when a user presses an input unit 530, the display unit may make sound or emit light to notify the user of an amount of electrical energy remaining in the energy storage unit 520.

When an amount of electrical energy remaining in the energy storage unit 520 is less than or equal to a threshold value, the controller 300 may control the power supply unit 510 to charge the energy storage unit 520. The controller 300 may acquire the threshold value from a memory. In addition, the controller 300 may receive the threshold value from an external device in a wired or wireless manner.

When the power supply unit 510 is operating normally, the controller 300 may periodically measure electrical energy stored in the energy storage unit 520 in order to prepare for an emergency. Also, when electrical energy of the energy storage unit 520 is less than or equal to the threshold value, the controller 300 may recharge the energy storage unit 520.

In order to prevent overcharging of the energy storage unit 520, when energy stored in the energy storage unit 520 is greater than or equal to a threshold value, the controller 300 may control the energy storage unit 520 to not be charged any more. According to the present disclosure, there is an effect of preventing an accident that may occur due to the overcharging or overheating of the energy storage unit 520.

In addition, when a charging signal is received from an input unit 2170 or a user terminal 2200, the controller 300 may charge the energy storage unit 520 with electrical energy. In addition, when a discharging signal is received from the input unit 2170 or the user terminal 2200, the controller 300 may prevent the energy storage unit 520 from being charged with electrical energy. According to the present disclosure, when a situation occurs in which an impact can be applied to the massage device 100 including the fully charged energy storage unit 520, a user may discharge the energy storage unit 520 to block a possibility of an accident in advance. A situation in which an impact may be applied may mean a case in which a natural disaster occurs or the massage device 100 is delivered or moved.

In addition, the massage device 100 may include an impact detection sensor or a heat detection sensor. When the impact detection sensor detects an impact that is greater than or equal to a critical impact or the heat detection sensor detects a temperature that is greater than or equal to a critical temperature, the controller 300 may discharge the energy storage unit 520. Therefore, even when the massage device 100 is exposed to an abnormal environment such as fire or earthquake, secondary damage by the massage device 100 may not occur.

When the supply of electrical energy from the power supply unit 510 is cut off, the controller 300 may store log information, which includes a time at which the supply of electrical energy from the power supply unit 510 is cut off, a time at which the supply of electrical energy from the power supply unit 510 is started, a voltage supplied from the power supply unit 510, a current supplied from the power supply unit 510, an operating state of the massage device 100, an amount of electrical energy remaining in the energy storage unit 520, and an operating time of a back angle actuator 540 or an operating time of a leg angle actuator 550, in a memory. The controller 300 may periodically collect the log information.

The operating state of the massage device 100 may include a massage mode, whether actuators included in the massage device 100 are operated, or a current or voltage consumed by each of the actuators.

The massage mode may represent a combination of information about a massage sequence, a massage type, a massage time, a massage intensity, a massage position, a temperature of the massage device, or a massage posture.

The massage position may mean a body part of a user being massaged by the massage device 100. The massage device 100 may provide a massage to a body part of a user by controlling an actuator positioned at a corresponding part to move.

The massage type may represent a tapping operation, a kneading operation, or a complex operation performed on a user by the massage device 100. The massage device 100 may control the actuator to move based on information about the massage type.

The massage time represents a time during which the massage device 100 provides a massage to a user. The massage device 100 may determine a time during which a massage is to be provided to a user based on information about the massage time.

The massage intensity represents an intensity with which the massage device 100 presses, kneads, or taps a user. The massage device 100 may control the actuator to adjust an intensity of pressing, kneading, or tapping a user. The intensity of pressing, kneading, or tapping the user may vary according to a body part.

The massage posture may represent a posture taken by a user when the user receives a massage while sitting on the massage device 100. A shape of the massage device 100 may be changed by a driving unit or the actuator, and based on the shape of the massage device 100, the massage device 100 may lay a user down, stand the user up, bend the legs of the user, or spread the legs of the user.

The massage sequence indicates a change over time of information about the massage intensity, the massage position, the temperature of the massage device, or the massage posture. The massage device 100 may provide various massages according to a time based on the massage sequence. For example, the legs of a user may be intensively massaged for a first time, and the back of the user may be intensively massaged for a second time.

Based on log information according to a time stored by the massage device 100, a user can find a cause why the massage device 100 abnormally operates. For example, the user can identify whether the power supply unit 510 operates abnormally due to a power outage or disconnection, whether an abnormality occurs in the power supply unit 510, or whether the power supply unit 510 temporarily fails to smoothly supply power due to an abnormal overload applied to the actuator.

Also, when the power supply unit 510 does not supply electrical energy for a certain time, the controller 300 may control the energy storage unit 520 to discharge electrical energy. The certain time may be a time sufficient for a user to escape from the massage device 100. For example, the certain time may be several tens of hours. The massage device 100 may discharge electrical energy stored in the energy storage unit 520 to prevent secondary damage by the energy storage unit 520 in an unpredictable situation. For example, in preparation for a situation in which the massage device 100 is overheated, a surge is applied to the massage device 100, or the massage device 100 is submerged in water, the massage device 100 may discharge electrical energy of the energy storage unit 520 after a certain time.

In addition, when the power supply unit 510 does not supply electrical energy for a certain time, the controller 300 may control the massage device 100 to return to an initial state. That is, even when a user does not press the input unit 530, by using energy of the energy storage unit 520, the controller 300 may control the massage device 100 to return to the initial state. When the massage device 100 is in the initial state, the massage device 100 may be in a state in which a mechanical load is less applied thereto. Therefore, when the massage device 100 maintains a posture rather than the initial state for a long time, a lifespan of parts of the massage device 100 may be shortened. Therefore, when the massage device 100 maintains a posture rather than the initial state for a long time, the controller 300 may automatically control the massage device 100 to return to the initial state.

In addition, when the massage device 100 automatically returns to the initial state, an alarm may be generated. A user may know that the massage device 100 will return to the initial state and may move away from the vicinity of the massage device 100 or prepare for an unexpected situation. In addition, the massage device 100 may include a proximity sensor for measuring whether there are objects therearound. The massage device 100 may return to the initial state only when there are no object therearound.

In addition, when the surroundings are dark, there is a possibility that a user collides with the massage device 100 while walking around. Accordingly, when it is determined that an object is approaching based on a signal from the proximity sensor, the controller 300 may control the output unit to make sound or emit light. Therefore, according to the present disclosure, it is possible to prevent a user from colliding with the massage device 100. Here, the controller 300, the proximity sensor, or the output unit may operate by receiving electrical energy from at least one of the power supply unit 510 and the energy storage unit 520.

The massage device 100 may perform operation 810 in which the energy storage unit stores electrical energy supplied from the power supply unit. In addition, the massage device 100 may perform operation 820 in which, when the supply of electrical energy from the power supply unit is cut off, the input unit receives an input from a user. Furthermore, the massage device 100 may perform operation 830 in which, based on a signal from the input unit 530, the back angle actuator 540 receives electrical energy from the energy storage unit 520 and moves a body massage unit 2100 such that the massage device 100 is in an initial state. In addition, the massage device 100 may perform operation 840 in which, based on a signal from the input unit 530, the leg angle actuator 550 receives electrical energy from the energy storage unit 520 and moves a leg massage unit 2300 such that the massage device 100 is in an initial state.

Also, the controller 300 may perform an operation in which, when the supply of electrical energy from the power supply unit 510 is cut off, a light source included in the input unit 530 is controlled to flicker light for a predetermined time using electrical energy supplied to the energy storage unit 520.

In addition, the controller 300 may perform an operation of measuring an amount of electrical energy remaining in the energy storage unit. Furthermore, the controller 300 may operate using electrical energy supplied from the power supply unit 510 or the energy storage unit 520.

In addition, the massage device 100 may allow the back angle actuator 540 or the leg angle actuator 550 to return to an initial state using a mechanical elastic body. For example, the back angle actuator 540 or the leg angle actuator 550 maintains a set rotation angle when receiving electrical energy but may rotate freely when not receiving electrical energy. In addition, the elastic body may apply a force to the back angle actuator 540 or the leg angle actuator 550 such that the back angle actuator 540 or the leg angle actuator 550 returns to the initial state. Due to the elastic body, the massage device 100 may return to an initial state without the aid of the energy storage unit 520.

Various embodiments have been mainly described so far. It will be understood by those skilled in the art that the present disclosure may be embodied in various other forms without departing from the spirit or essential characteristics thereof. Therefore, the disclosed embodiments should be considered in an illustrative rather than a restrictive sense. The scope of the present disclosure is defined by the appended claims rather than by the foregoing description, and all differences within the scope of equivalents thereof should be construed as being included in the present disclosure.

Meanwhile, the above-described embodiments of the present disclosure may be made in a program executable on a computer and may be implemented in a general-purpose digital computer operating the program using a computer-readable recording medium. The computer-readable recording medium includes a storage medium, such as a magnetic storage medium (for example, a ROM, a floppy disc, or a hard disc) or an optical reading medium (for example, a CD-ROM or a DVD).

1. A massage device comprising:
an energy storage unit configured to store electrical energy supplied from a power supply unit;
an input unit configured to receive an input from a user when supply of the electrical energy from the power supply unit is cut off;
a back angle actuator which receives the electrical energy from the energy storage unit based on the input unit and moves a body massage unit such that the massage device is in an initial state; and
a leg angle actuator which receives the electrical energy from the energy storage unit based on the input unit and moves a leg massage unit such that the massage device is in the initial state.

2. The massage device of claim 1, wherein, when the supply of the electrical energy from the power supply unit is cut off, based on the input unit, the electrical energy from the energy storage unit is supplied to at least one of the back angle actuator and the leg angle actuator.

3. The massage device of claim 1, wherein, when the supply of the electrical energy from the power supply unit is cut off, a light source included in the input unit flickers light for a preset time using the electrical energy supplied to the energy storage unit.

4. The massage device of claim 1, further comprising a controller which operates using the electrical energy supplied from the power supply unit or the energy storage unit and measures an amount of the electrical energy remaining in the energy storage unit.

5. The massage device of claim 4, further comprising a display unit configured to display the amount of the electrical energy remaining in the energy storage unit based on the amount of the electrical energy remaining in the energy storage unit.

6. The massage device of claim 4, wherein, when the amount of the electrical energy remaining in the energy storage unit is less than or equal to a threshold value, the controller controls the power supply unit to charge the energy storage unit.

7. The massage device of claim 4, wherein, when the supply of the electrical energy from the power supply unit is cut off, the controller stores log information, which includes a time at which the supply of the electrical energy from the power supply unit is cut off, a time at which the supply of the electrical energy from the power supply unit is started, a voltage supplied from the power supply unit, a current supplied from the power supply unit, an operating state of the massage device, the amount of the electrical energy remaining in the energy storage unit, and an operating time of the back angle actuator or an operating time of the leg angle actuator, in a memory.

8. The massage device of claim 4, wherein, when the power supply unit does not supply the electrical energy for a certain time, the controller controls the energy storage unit to discharge the electrical energy.

9. A method of operating a massage device, the method comprising:
storing, by an energy storage unit, electrical energy supplied from a power supply unit;
when supply of the electrical energy from the power supply unit is cut off, receiving, by an input unit, an input from a user;
receiving, by a back angle actuator, the electrical energy from the energy storage unit based on the input unit and moving a body massage unit such that the massage device is in an initial state; and
receiving, by a leg angle actuator, the electrical energy from the energy storage unit based on the input unit and moving a leg massage unit such that the massage device is in the initial state.

10. The method of claim 9, further comprising, when the supply of the electrical energy from the power supply unit is cut off, flickering, by a light source included in the input unit, light for a predetermined time using the electrical energy supplied to the energy storage unit.

11. The method of claim 9, further comprising measuring, by a controller, an amount of the electrical energy remaining in the energy storage unit,
wherein the controller operates using the electrical energy supplied from the power supply unit or the energy storage unit.

12. The method of claim 11, further comprising, when the supply of the electrical energy from the power supply unit is cut off, storing, by the controller, log information, which includes a time at which the supply of the electrical energy from the power supply unit is cut off, a time at which the supply of the electrical energy from the power supply unit is started, a voltage supplied from the power supply unit, a current supplied from the power supply unit, an operating state of the massage device, the amount of the electrical energy remaining in the energy storage unit, and an operating time of the back angle actuator or an operating time of the leg angle actuator, in a memory.
